(19) United States
(12) Patent Application Publication
(10) Pub. No.: US 2019/0176336 A1
(43) Pub. Date: Jun. 13, 2019

(54) DEVICE CONTROLLER

(71) Applicant: CASIO COMPUTER CO., LTD, Tokyo (JP)

(72) Inventor: Tatsunori Takagi, Fussa-shi (JP)

(21) Appl. No.: 16/201,536

(22) Filed: Nov. 27, 2018

(30) Foreign Application Priority Data
Dec. 13, 2017 (JP) 2017-238616

(51) Int. Cl. B25J 9/16; G05B 19/042

(52) U.S. Cl. CPC B25J 9/1694; G05B 19/0423; B25J 9/161; B25J 9/1656

(57) ABSTRACT

A processor is configured to perform signal output processing for outputting an instruction signal indicative of an operational content corresponding to sensor data which is output from a sensor configured to sense an external environment, first device-control processing for controlling an operation of a device which is configured to perform the operation, based on the instruction signal output in the signal output processing, and second device-control processing for controlling the operation of the device, based on an interrupt signal which is output when the sensor data satisfies a predetermined condition processing.

### CROSS-REFERENCE TO RELATED APPLICATIONS

This application is based upon and claims the benefit of priority from Japanese Patent Application No. 2017-238616, filed Dec. 13, 2017, the entire contents of which are incorporated herein by reference.

### BACKGROUND OF THE INVENTION

### 1. Field of the Invention

The present invention relates to a device controller suitable for apparatuses including, for example, a pet robot.

### 2. Description of the Related Art

A robot controller for controlling a robot to encourage user's autonomous activity has been proposed (See, for example, Jpn. Pat. Appln. KOKAI Publication No. 2016-135530).

### SUMMARY OF THE INVENTION

According to one aspect of the present invention, there is provided a device controller comprising: a processor, wherein the processor is configured to perform signal output processing for outputting an instruction signal indicative of an operational content corresponding to sensor data which is output from a sensor configured to sense an external environment, first device-control processing for controlling an operation of a device which is configured to perform the operation, based on the instruction signal output in the signal output processing, and second device-control processing for controlling the operation of the device, based on an interrupt signal which is output when the sensor data satisfies a predetermined condition processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing a partial configuration of functional circuitry for a pet robot according to one embodiment of the invention; and

FIG. 2 is a flowchart showing contents of overall processing for addressing a sound input in the context of the embodiment.

### DETAILED DESCRIPTION OF THE INVENTION

A certain embodiment of the invention will be described with reference to the drawings, assuming an instance where the invention is applied to a pet robot (device).

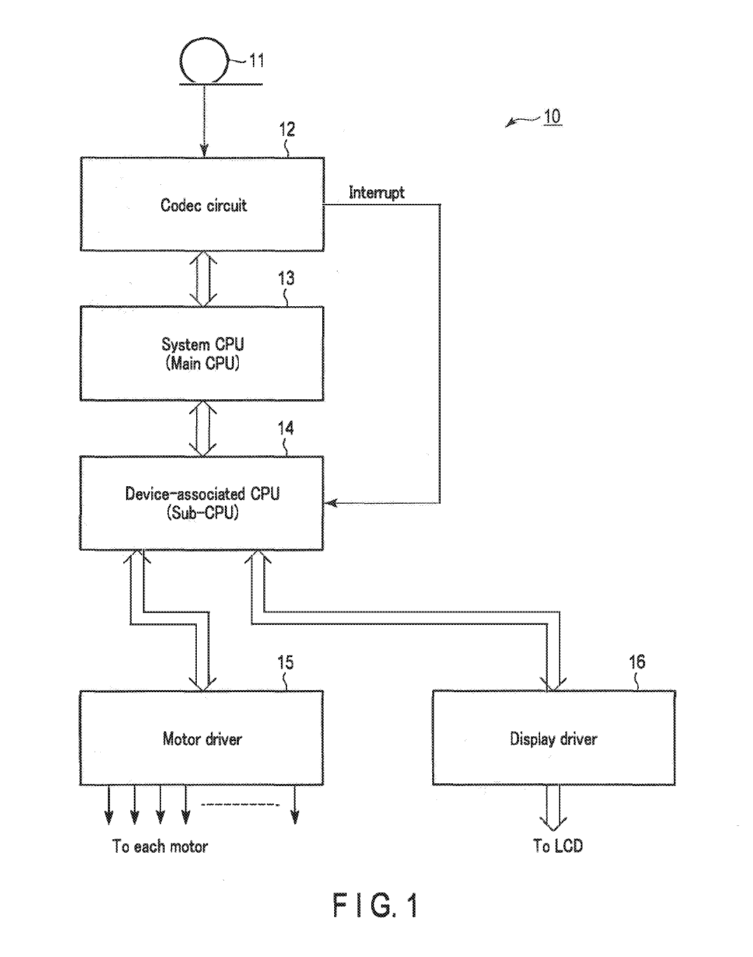

FIG. 1 is a block diagram schematically showing a partial configuration of the functional circuitry for a pet robot 10 according to this embodiment. It will be assumed that this pet robot 10 is adapted to analyze pre-registered instructions, etc. by sound recognition processing and to perform a variety of prescribed operations, in response to external stimuli, such as a user's call or instruction and an environmental sound, input via a microphone as one of the sensors which the pet robot 10 is furnished with.

As shown in the figure, a sound signal that corresponds to an external sound input via a microphone 11 (which may be a built-in component at a head portion of the pet robot 10) and the directivity of the microphone 11 itself is converted into digital data and coded according to a given coding format at a codec circuit 12, and supplied to a system CPU 13.

If a sound signal having a sound pressure level equal to or higher than a threshold is input to the codec circuit 12, the codec circuit 12 directly sends an interrupt signal to a device-associated CPU 14 (described later).

The system CPU 13 may serve as a main CPU in the pet robot 10 and take total control over the pet robot 10. More specifically, the system CPU 13 performs the sound recognition processing for the sound data supplied from the codec circuit 12 and generates, based on the predetermined contents for the result of the sound recognition processing, an instruction signal indicative of an operation to be performed by the pet robot 10 at that time point. The system CPU 13 outputs the generated instruction signal to the device-associated CPU 14.

The device-associated CPU 14 may serve as a sub-CPU in the pet robot 10 and control each physically operable device in the pet robot 10 to drive according to the instruction signal from the system CPU 13. Specifically, the device-associated CPU 14 performs various control including rotary drive control for many stepping motors (not shown) connected via a motor driver 15, display drive control for liquid crystal display (LCD) panels connected via a display driver 16, and further output control for sounds from a speaker (not shown).

The stepping motors driven by the motor driver 15 are provided for the respective joint axes in the limbs and neck of the pet robot 10. The liquid crystal display panels are disposed at the eyes of the pet robot 10, as well as a display unit in, for example, the chest of the pet robot 10.

In the present embodiment, the codec circuit 12, the system CPU 13, and the device-associated CPU 14 form a device controller to control devices such as the stepping motors and the display unit.

Next, operations according to the embodiment will be described.

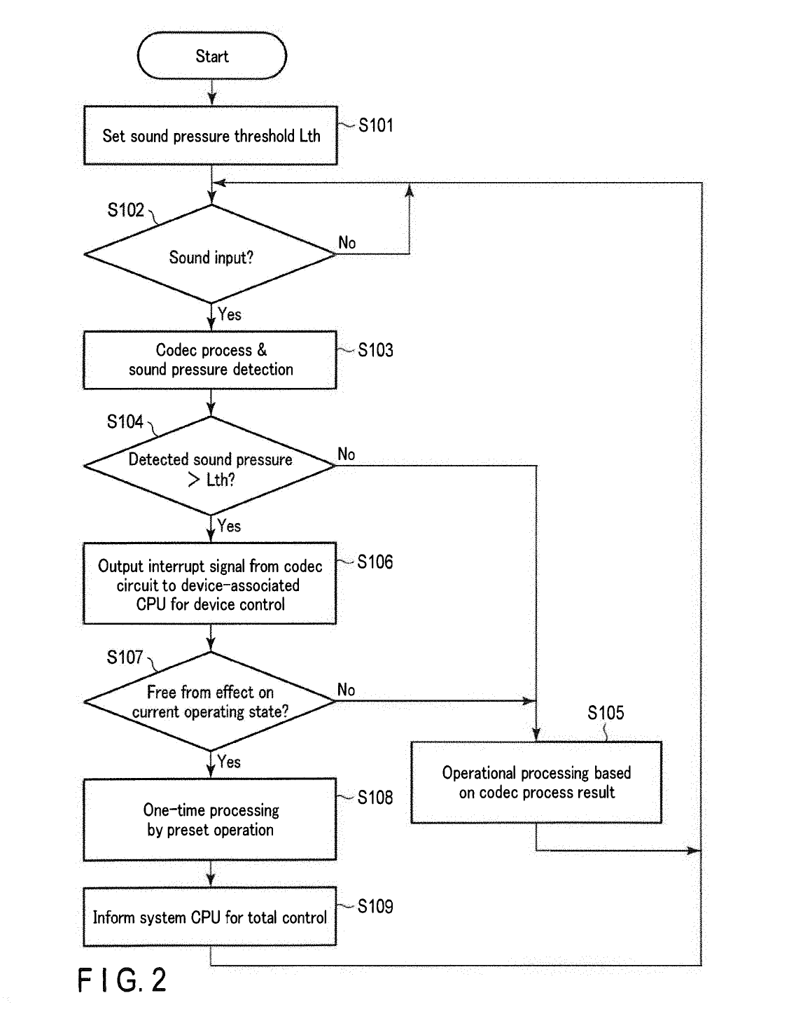

FIG. 2 is a flowchart showing contents of the overall processing for addressing a sound input to the pet robot 10. The processing is performed mainly by the system CPU 13 as a main CPU in cooperation with the device-associated CPU 14 as a sub-CPU.

First, at the initial stage upon power activation, the system CPU 13 sets a sound pressure level Lth which will serve as a threshold for input sounds (step S101).

This sound pressure threshold Lth may be a fixed value prepared in advance, or may be a variable value set to increase or decrease from the fixed value using a predetermined coefficient in accordance with the surrounding sound pressure levels measured using the microphone 11 at a given time point.

Subsequently, the codec circuit 12 determines the occurrence of any call, etc. for the pet robot 10 under the control of the system CPU 13, by determining whether or not there is an input sound via the microphone 11 with reference to the preset minimum sound pressure level (step S102).

If it is determined that no input sound is obtained via the microphone 11 and that there is no call, etc. for the pet robot 10 (No in step S102), the codec circuit 12 repeats the processing in step S102 to stand by until any call, etc. for the pet robot 10 occurs.

If it is determined in step S102 that an input sound is obtained via the microphone 11 and that there is a certain call, etc. for the pet robot 10 (Yes in step S102), the codec circuit 12 digitizes and codes the received sound signal and detects the sound pressure level from the result of digitization processing.

The codec circuit 12 determines whether or not the detected sound pressure level exceeds the threshold Lth set as above (step S104).

If it is determined that the detected sound pressure level does not exceed the threshold Lth (No in step S104), the codec circuit 12 sends the coded sound data to the system CPU 13 as it is.

The system CPU 13 performs the sound recognition processing for the sound data input from the codec circuit 12 and determines, based on the obtained recognition result, what operation the pet robot 10 should perform as a normal operation in accordance with an operation program. The system CPU 13 generates an instruction signal consistent with the determination result and sends the generated instruction signal to the device-associated CPU 14.

Upon receipt of the instruction signal, the device-associated CPU 14 follows the contents of the instruction signal to control the motor driver 15 to drive the corresponding stepping motors for rotation, and to control the display driver 16 to drive the corresponding liquid crystal display panels for display of a content as instructed.

After the system CPU 13 and the device-associated CPU 14 perform the processing control for the normal operation corresponding to the sound data coded by the codec circuit 12 (step S105), the processing flow returns to step S102 in preparation for the next sound input.

If it is determined in step S104 that the detected sound pressure level exceeds the threshold Lth, for example, when the pet robot 10 is given a stimulus of a surprising shout (Yes in step S104), the codec circuit 12 outputs an interrupt signal directly to the device-associated CPU 14 (step S106).

Upon receipt of the interrupt signal, the device-associated CPU 14 determines whether or not the current operating state would be subject to any negative effect, for example lead to a tumble, etc., due to this interrupt signal by determining whether or not the operational content that was being performed via the motor driver 15 and the display driver 16 right before the receipt of the interrupt signal and the operational content preset for the interrupt signal fall outside the prohibited combinations of operations (step S107).

If it is determined that the most recent operational content and the operational content preset for the interrupt signal form a prohibited combination, and that a negative effect on the current operating state is expected (No in step S107), the device-associated CPU 14 deems the interrupt signal from the codec circuit 12 to be an invalid signal, and proceeds to step S105 discussed above so that the operation up to then will continue.

If, in step S107, the most recent operational content and the operational content preset for the interrupt signal are not found to be forming a prohibited combination, and it is determined that a negative effect would not be caused on the current operating state (Yes in step S107), the device-associated CPU 14 handles the interrupt signal from the codec circuit 12 as a valid signal so that a predetermined operation will be performed in place of the operation up to then. In this case, the device-associated CPU 14 controls the motor driver 15 to drive the stepping motors for rotation and controls the display driver 16 to drive the liquid crystal display panels for display of a content as instructed, in order to perform the predetermined operation that may be a jumping action with an astonished look, displaying surprised eyes, and so on (step S108).

The device-associated CPU 14 informs the system CPU 13 of the execution of this one-time processing corresponding to the interrupt signal (step S109). The processing flow then returns to step S102 in preparation for the next sound input.

Note that multiple operational contents may be set for the one-time processing to be executed by the device-associated CPU 14 upon receipt of the interrupt signal from the codec circuit 12. It is possible to adopt a control where one operation is randomly selected from these multiple operational contents, or a control where a higher priority for selection is given to an operation that would be unlikely to produce a negative effect if performed right after the operation up to the receipt of the interrupt signal.

As described in detail, the embodiment enables a prompt response to the external stimuli while reducing the processing load on the system CPU 13 as a main CPU.

Also, the embodiment adopts a configuration in which the device-associated CPU 14 invalidates the input of an incoming interrupt signal from the codec circuit 12 if it determines the likelihood of a negative effect, such as making the pet robot 10 lose its posture, based on determining the combination of the operational content that was in execution right before the receipt of the interrupt signal and the operational content for execution corresponding to the interrupt signal. According to the embodiment as such, disturbing the behavior of the pet robot 10 due to undue stimuli from the surroundings can be avoided.

Moreover, the embodiment adopts a configuration in which the device-associated CPU 14 as a sub-CPU, upon performing the one-time operation addressing the interrupt signal from the codec circuit 12, notifies the system CPU 13 as a main CPU of the executed operational content. According to the embodiment as such, even when the device-associated CPU 14 has temporarily served as an executing entity in response to a breaking external stimulus, the system CPU 13 that takes total control over the operations of the pet robot 10 can always be updated with the results of execution by the device-associated CPU 14 and utilize these results for subsequent controlling events.

The foregoing description of the embodiment has assumed that the system CPU 13 sets a sound pressure level Lth at the initial stage after power activation of the pet robot 10, for the codec circuit 12 to use it as a threshold for making a determination using the volume of input sounds. However, such a threshold constituting the basis of determinations may be discretionarily set by a user. Furthermore, the threshold may be set to have a certain range and vary according to time slots, etc., so that the operations of the pet robot 10 can be tailored.

Also, the foregoing description of the embodiment has assumed that sounds are input via the microphone 11 as the external stimuli to the pet robot 10, and responding actions are taken based on their sound pressures. However, for the detection of external stimuli, the invention is not limited to sounds, and it is likewise possible to detect various external stimuli so that the pet robot 10 will exhibit changeful behavior. For example, it is possible to detect an outside image via an image sensor, an external force or a state of posture or drop via an acceleration sensor, brightness via a brightness sensor, a temperature or a moisture content of ambient air via a temperature sensor or a humidity sensor, an atmospheric pressure, an operational pressure, or a water pressure via a pressure sensor, and so on.

The foregoing description of the embodiment has assumed an instance where the invention is applied to a robot having a main CPU and a sub-CPU, but the invention is not limited to such application. The invention is also applicable to a robot, etc. having a single CPU. Examples of the control subject in that instance include a subject, e.g., a robot, adapted to operate according to software of a structure having program areas for differently controlling the overall operation of the subject and the driving conditions of multiple terminal devices in individual operating motions. The control subject may also be a subject involving a multi-processor structure for controlling multiple terminal devices by the respective microprocessors. There may be provided a non-transitory computer-readable storage medium having the software (program) stored thereon which controls a computer of the device controller to perform control.

It is also noted that, while the embodiment above adopts the codec circuit 12 for determining an external stimulus and outputting an interrupt signal, the embodiment may adopt means or a unit for determining an external stimulus and outputting an interrupt signal separately from the codec circuit 12.

Furthermore, the invention is not only applicable to robots, but is also applicable likewise to various electronic equipment adapted to operate in response to external stimuli.

As a matter of course, the invention is not limited to the embodiment described above, but can be modified in various ways for practical implementation without departing from the gist of the invention. The various embodiments may be discretionarily combined for implementation, and such combinations will produce combined effects. Moreover, the embodiment involves various aspects, and appropriate combinations of the disclosed features will permit various inventions to be derived. For example, if omission of several features from the entire configuration or structure disclosed for the embodiment realizes the intended object and provides the effects, the configuration or structure after such omission may be derived as an invention.

What is claimed is:

1. A device controller comprising:
a processor,
wherein the processor is configured to perform
signal output processing for outputting an instruction signal indicative of an operational content corresponding to sensor data which is output from a sensor configured to sense an external environment,
first device-control processing for controlling an operation of a device which is configured to perform the operation, based on the instruction signal output in the signal output processing, and
second device-control processing for controlling the operation of the device, based on an interrupt signal which is output when the sensor data satisfies a predetermined condition processing.

2. The device controller according to claim 1, further comprising a converter configured to output the interrupt signal when the sensor data satisfies the predetermined condition,
wherein the second device-control processing controls the operation of the device, based on the interrupt signal output from the converter.

3. The device controller according to claim 2, wherein
the converter is configured to output a sensing output of the sensor as the sensor data, and
the signal output processing outputs the instruction signal indicative of an operational content corresponding to the sensor data output from the converter.

4. The device controller according to claim 1, wherein the processor is configured to further perform determination processing for determining whether or not an operation corresponding to the interrupt signal is to be performed based on an operational content of the device controlled right before input of the interrupt signal.

5. The device controller according to claim 1, wherein the processor is configured to further perform notification processing for notifying, after controlling the operation of the device based on an operational content of the device preset for the interrupt signal, the signal output processing.

6. The device controller according to claim 2, wherein the predetermined condition used by the converter is optionally settable.

7. The device controller according to claim 1, wherein the second device-control processing controls the operation of the device, without executing the first device-control processing.

8. The device controller according to claim 1, wherein
the processor is composed of a first processor and a second processor,
the first processor is configured to perform the signal output processing, and
the second processor is configured to perform the first device-control processing and the second device-control processing.

9. A device controlling method by a device controller, the method comprising:
a signal output step of outputting an instruction signal indicative of an operational content corresponding to sensor data which is output from a sensor configured to sense an external environment;
a first device-control step of controlling an operation of a device which is configured to perform the operation, based on the instruction signal output in the signal output step; and
a second device-control step of controlling the operation of the device, based on an interrupt signal which is output when the sensor data satisfies a predetermined condition.

10. The device controlling method according to claim 9, further comprising a conversion step of outputting the interrupt signal when the sensor data satisfies the predetermined condition,
wherein the second device-control step includes a step of controlling the operation of the device, based on the interrupt signal output in the conversion step.

11. The device controlling method according to claim 10, wherein
the conversion step includes a step of outputting a sensing output of the sensor as the sensor data, and
the signal output step includes a step of outputting the instruction signal indicative of an operational content corresponding to the sensor data output in the conversion step.

12. The device controlling method according to claim 9, further comprising a determination step of determining whether or not an operation corresponding to the interrupt signal is to be performed based on an operational content of the device controlled right before input of the interrupt signal.

13. The device controlling method according to claim 9, further comprising a notification step of notifying, after controlling the operation of the device based on an operational content of the device preset for the interrupt signal, the signal output step of the control.

14. The device controlling method according to claim 10, wherein the predetermined condition used by the conversion step is optionally settable.

15. A non-transitory computer-readable storage medium having stored thereon a program causing a computer of a device controller to function as:
a signal output unit which outputs an instruction signal indicative of an operational content corresponding to sensor data which is output from a sensor configured to sense an external environment;
a first device-control unit which controls an operation of a device which is configured to perform the operation, based on the instruction signal output by the signal output unit; and
a second device-control unit which controls the operation of the device, based on an interrupt signal which is output when the sensor data satisfies a predetermined condition.

16. The non-transitory computer-readable storage medium according to claim 15, wherein
the program further causes the computer to function as a converting unit which outputs the interrupt signal when the sensor data satisfies the predetermined condition, and
the second device-control unit controls the operation of the device, based on the interrupt signal output by the converting unit.

17. The non-transitory computer-readable storage medium according to claim 16, wherein
the converting unit outputs a sensing output of the sensor as the sensor data, and
the signal output unit outputs the instruction signal indicative of an operational content corresponding to the sensor data output by the converting unit.

18. The non-transitory computer-readable storage medium according to claim 15, wherein the program further causes the computer to function as a determining unit which determines whether or not an operation corresponding to the interrupt signal is to be performed based on an operational content of the device controlled right before input of the interrupt signal.

19. The non-transitory computer-readable storage medium according to claim 15, wherein the program further causes the computer to function as a notifying unit which notifies, after controlling the operation of the device based on an operational content of the device preset for the interrupt signal, the signal output unit of the control.

20. The non-transitory computer-readable storage medium according to claim 16, wherein the predetermined condition used by the converting unit is optionally settable.
